(19) United States
(12) Patent Application Publication
(10) Pub. No.: US 2004/0255987 A1
(43) Pub. Date: Dec. 23, 2004

(54) Method and device for draining waste water in the inner bend of a beam blank casting machine

(76) Inventors: Heinz-Dietrich Schneider, Duisburg (DE); Jurgen friedrich, Mulheim (DE); Herbert Brotzki, Duisburg (DE); Dirk Letzel, Ratingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/488,903

(22) PCT Filed: Sep. 2, 2002
(86) PCT No.: PCT/EP02/09779

(30) Foreign Application Priority Data
Sep. 5, 2001 (DE) 10143419.7

(51) Int. Cl. B08B 3/00

(52) U.S. Cl. 134/34; 134/104.2; 134/198

(57) ABSTRACT

The invention relates to a method and a device for draining waste water (7) from the inner bend of the strand guide (3) of a beam blank casting machine. In order to drain said waste water from the beam blank in a targeted and controlled manner, a draining device (6) is arranged in the area of the strand guide (4) for the beam blank, said device being provided with jet nozzles (8). Under the effect of jets (13, 14) directed with high energy against the water flow direction, the waste water is lifted on the formation of a banking-up pressure by means of said draining device (6), directed at the lateral edges (11) of the inner bend (4) of the beam blank (10) and collected in a sintered groove (9), arranged thereunder.

The invention relates to a method of and a device for the draining of runoff water from the inner bend of the strand path of a beam blank casting machine.

In a beam blank casting machine, the cast shape is brought to hardening through its cross section within the strand guide path. The initial solidification occurs in the mold by heat conduction to the water cooled copper plates. The further heat abstraction is effected within the strand guide by contact with the strand guide rollers, by heat removal by means of water spray nozzles and by thermal radiation from the strand. The beam blank profile [cross sectional shape] is produced with a casting radius. Because of this operational principle, runoff water collects along the inner arc or bend of the beam blank profile. This tends to increase in the strand withdrawal direction from one row of nozzles to the next and limits the heat transfer by spray cooling and gives rise on the other hand to a water accumulation upstream of the cutting torch machine. It is known to pick up excess water by a suction device and separately drain it from the continuous casting apparatus.

One such suction device for a beam blank casting machine is known from the Japanese patent document JP 58 15 7559 A1. According to this previously known device, the cooling water residue is picked up by an inlet suction pipe shaped with a blade-like configuration and at which an outlet pipe is connected at whose end, with a round cross section, a subatmospheric pressure is applied to draw off the water by suction. The subatmospheric pressure is produced through a concentric jacket pipe in which a subatmospheric air pressure flows to the end of the discharge pipe. The suction pressure is correspondingly low and allows only the last residues of the cooling water to be drawn off by suction. The inlet suction pipe has an inclined surface for draining the greater quantities of the residual cooling water in that the inlet suction pipe is turned in a transverse direction opposite the oncoming water so that the cooling water residue can run off to both sides of the cast strand and is separately collected. In accordance with the beam blank profile casting principles, the beam blank profile or preprofile strand is so shaped that the residual water quantity is held between the lateral profile edges so that it can be removed only by lifting it from between these edges. Since the location and space conditions is confined because of the support roller frame, there is insufficient space to provide effective devices for removing the cooling water. In addition the space which is available is already so utilized that additional devices can only contribute problems.

The present invention thus has as its object to provide a method and a device for draining runoff water from the inner bend of a beam blank profile, which can be accommodated within the narrow structural limits available in continuous casting apparatus for preapproval strands and which can reliably allow at the same time a removal of most of the residual runoff water quantity.

The object set forth is achieved according to the invention in a method of draining runoff water from the inner bend of the guided strand of a beam blank casting machine in accordance with the preamble of claim 1 in that the runoff water which collects in the inner bend of the beam blank profile is lifted in the region of a drain device by the effect of a high energy jets directed against the travel direction of the strands and forming a damming pressure, thereby raising the water over the lateral profile edges of the inner arc and enabling the water to be collected in a sinter [cinder] channel arranged thereunder.

The invention utilizes water which is available for cooling to provide the pressure of the jets to create the drain effect at the transition location to the drain device. The jets of this medium which are trained from the bundled nozzles against the oncoming runoff water lift the runoff water within the inner arc of the beam blank profile easily and guide it over the edges of the beam blank profile so that it can flow into the sinter channel lying therebelow. The main advantage is that the flange edges of the beam blank profile do not undergo any undefined cooling as a result of the draining of the water.

In a feature of the method according to the invention it is proposed that the nozzle jets be generated using water under pressure. Advantageously, however, the nozzle jets can be produced with air or an air/water mixture.

After the lifting of the runoff water over the lateral edges of the beam blank profile, the runoff water flows in a controlled manner in the drain device. The thus discharged water flows in the sinter trough lying below the drain device. The purpose of the sinter trough is to collect the runoff water, the scale and the casting powder residues from the cooling process from the bend of the casting. In a longitudinal section through such an apparatus, it is located below the bend of the casting and is of such width that the water falling from the bend of the casting and which is enriched with scale and casting powder residues, can be collected to the greatest extent possible. The collected cooling water which is loaded with solids can, in accordance with another feature of the invention, be treated in the apparatus for water economy and then returned as cooling water to the beam blank casting machine.

A device for draining the runoff water from the inner bend of the strand guide of the beam blank casting machine for carrying out the method encompasses a drain device at the lower region of the inner bend of the strand between lateral edges of the beam blank profile, whereby the drain device can be adjusted as to its height in guide rails in which the drain device is displaceable, and is connected to a supply pipe for the pressure medium for producing the nozzle jets. Advantageously the drain device for the runoff water, for functional reasons as well as for reasons of space, is provided at the lower part of the casting bend and has cooling water nozzles serving to spray the casting jet nozzles being directed opposite the direction of flow of the runoff water in the inner bend of the pump blank profile and capable of producing energy-rich jets.

To lift the runoff water in the beam blank profile and guide it over the profile edges, jet nozzles are used which produce water jets for example in the range of about 10 bar or to produce air jets or jets of a water/air mixture for example in the region of about 6 bar.

In a further development of the drain device, the sinter channel is provided below the drain device in the region thereof to collect the overflowing runoff water from the inner bend of the beam blank profile and has at least one discharge fitting which advantageously is connected with a water cleaning and water recycling unit for water economy.

A beam blank casting machine can be provided in accordance with the cast shape for any optional number of cast strands. If a beam blank casting machine is conceived for a plurality of cast shapes, the drain device can be equipped with a replaceable head. Depending upon the cast shape, the nozzle arrangement/drain arrangement will be provided with dimensions determined by the dimensions of the beam blank, whereby in each case the nozzle arrangement/drain arrangement can be provided in a defined position for the particular beam blank. In line with this, the drain device can also be positionable by means of rollers with an offset to the inner bend. The position which is thereby assumed by the drain device can be the optimum position for the process.

In an advantageous feature of the drain device it is further provided that the latter, at the lower range of the inner bend of the beam blank profile, be of adjustable height between the lateral edge profile, guided between guide rails and having at an upper end a feed line for the pressure medium which also is arranged to be height adjustable. Preferably protective plates can be provided in the regions of the drain device on the edges of the beam blank profile. Details, features and further advantages of the invention are given in the following description of an embodiment schematically illustrated in the drawing. It shows:

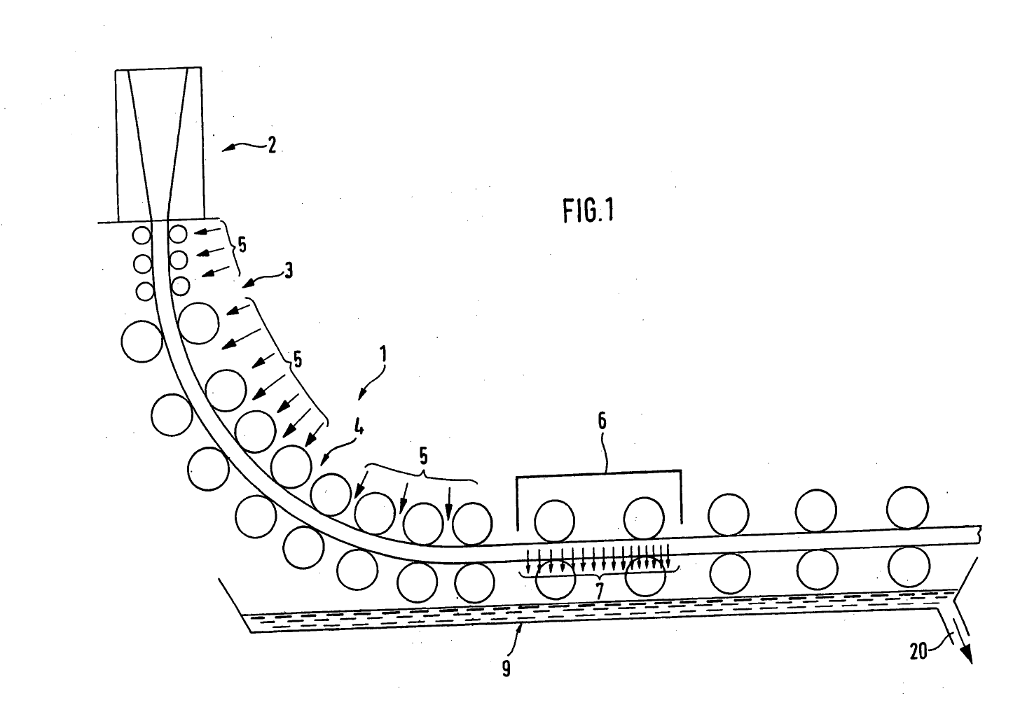

FIG. 1 a side elevational view of a beam blank casting machine, encompassing a mold and, beneath the mold, a strand guide with an inner bend as well as a drain device arranged therein for the runoff water as well as a sinter trough lying therebelow,

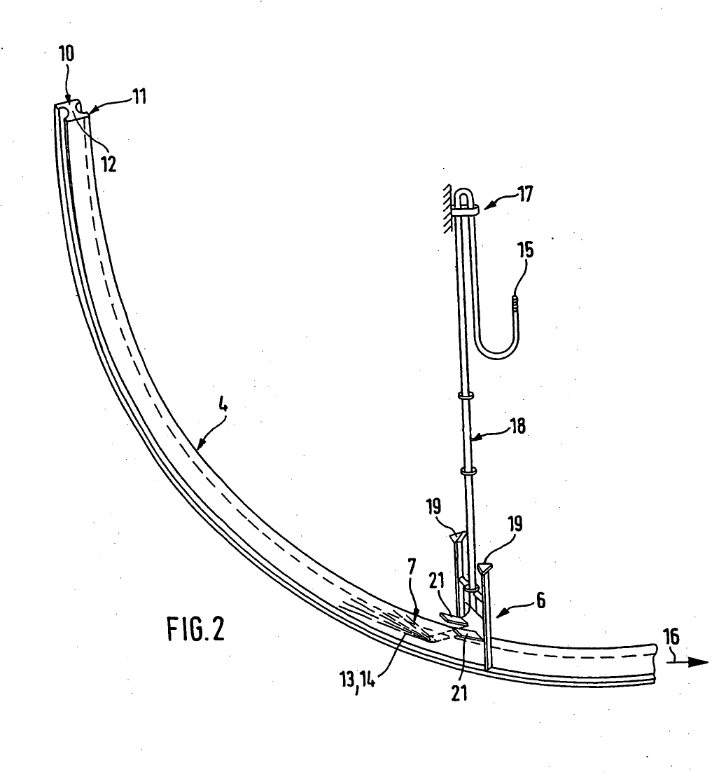

FIG. 2 a beam blank inner bend in a side elevational view with the drain device arranged therein,

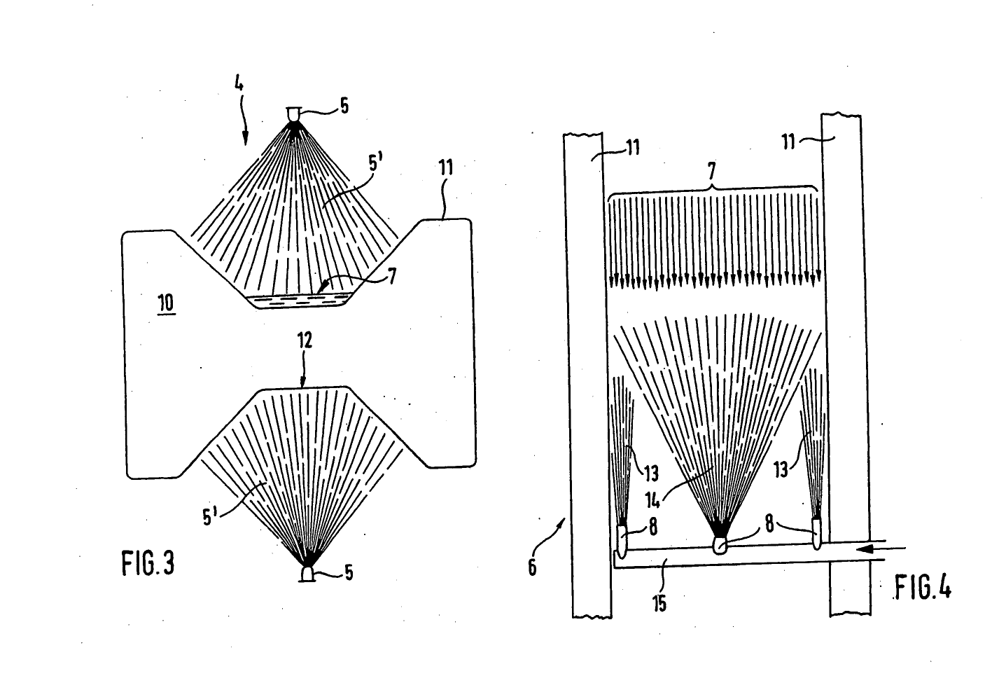

FIG. 3 the beam blank profile in cross section to the water runoff flow and the drain jet nozzles disposed at an upper portion and nozzle jets at a lower portion for uniform cooling,

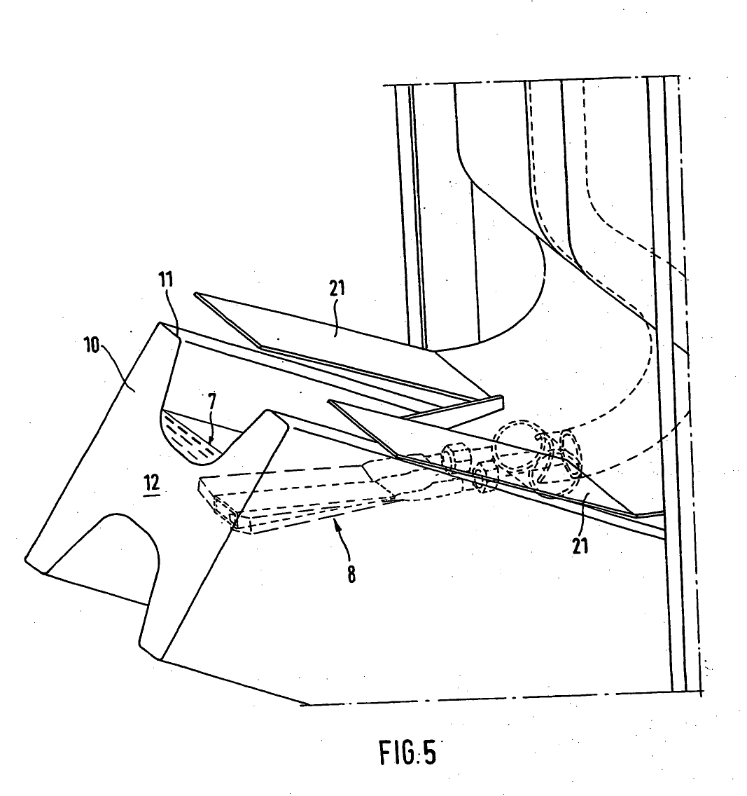

FIG. 4 a plan view of a region of the drain device with runoff water and spray jets directed opposite the runoff water,

FIG. 5 a perspective view of a section of the beam blank profile with a drain device.

In FIG. 1 a side of a beam blank casting machine can be seen which comprises a mold 2, a strand guide 3 with guide rollers with water spray nozzles 5, which direct the cooling water between the rollers of the strand guide 3 for cooling the cast beam blank for example, a preshaped beam for beam rolling from respective nozzles.

The sprayed cooling water collects in the inner bend of the strand guide 3 and runs in the inner bend 4 of the beam blank profile along the web thereof between the lateral profile edges 11 in the strand withdrawal direction. The runoff water adds, in the strand withdrawal direction, from nozzle row to nozzle row and limits on the one hand the heat transfer by spray cooling and gives rise, on the other hand, to an accumulation of water, which limits the controlled cooling down of the beam blank.

In order to prevent this, the run off water is drained away by means of a drain device 6 from the upper surface of the beam blank in the region of the beam blank inner bend. The runoff water 7 of the drain device is collected in a sinter trough 9 [channel] located beneath the strand guide and from this sinter trough 9, by means of a runoff fitting 20, is led to a treatment apparatus and from the latter is recycled among other things to the water-cooling device of the beam blank casting machine, not shown in detail, as part of the water economy system.

The drain device 6 is, as can be seen from FIG. 2, in the lower region of the inner bend of the strand guide 3 and fitted between the lateral profile edges 11 of the beam blank profile, the so-called “tips”, height adjustable between guide rails 19. At the upper end of the drain device 6, a supply pipe 18 is provided for the pressure medium which via a pipe bend is also guided for height adjustability in a guide 17.

The height adjustability of the drain device is provided to enable an optimum drain function depending upon the kind and amount of the runoff water and thus to enable control of the drain function and ensure the reliability thereof.

In FIG. 2 it has been shown purely schematically that the drain device 6 for draining the runoff water from the upper profile cross sections 10 of the beam blank is equipped with nozzles for forming a hard energy-rich jet wall by the jets 13, 14 and to support the function of the jets, protective plates 21 on the profile edges 11. The energy-rich jet wall is directed against the flow in the runoff direction of the runoff water and, by forming a dam for the runoff water lifts the latter over the lateral profile edges 11 of the inner bend of the beam blank profile so that the runoff water flows down into the sinter trough 9 (compare FIG. 1) located therebelow. For producing the jets 13 and 14, pressurized water is used. According to the invention, however, it is also possible to generate the jets 13 and 14 with air or an air/water mixture.

FIG. 3 shows the cross section of a beam blank profile with its web 12 and the lateral profile edges 11. From spray water nozzles, cooling jets 5′ are directed onto the beam blank profile. It can be seen that the runoff water 7 collects on the upper side of the web 12 and from the latter runs off downwardly in the strand travel direction.

FIG. 4 shows in a plan view the feature of draining the runoff water 7 from the web region 12 of the beam blank profile. For this purpose water under pressure is fed to the pressurized water connection 15 for the jet nozzles 8. The high energy jets 13, 14 are directed opposite to the runoff direction of the runoff water 7 and the jet energy is so dimensioned that the runoff water is lifted somewhat and laterally drained over the profile edges 11 of the beam blank profile.

FIG. 5 shows in a perspective view a piece of the beam blank profile in cross section 10 with the profile edges or “tips” and the middle web 12 which connects them as well as a nozzle arrange 8 for producing the jets which are inclined opposite the flood of the runoff water 7.

The method and device according to the invention is not limited to the described embodiment but encompasses also further configurational variants to the extent that they satisfy the concept of the invention.

### Reference Characters

1 Beam blank casting machine

2 Mold

3 Strand guide

4 Inner bend

5, 5′ Spray water nozzles, spray water

6 Drain device

7 Drain water

8 Nozzles (water/air)

9 Sinter trough

10 Beam blank cross section

11 Tip (edge)

12 Web

13 Nozzle jets

14 Nozzle jets

15 Pressurized water connection

16 Casting direction

17 Guide

18 Pressure pipe

19 Guide shapes

20 Drain device

21 Protective plates

1. A method of draining runoff water (7) from the inner bend of the strand guide (3) of a beam blank casting machine, characterized in that the accumulating runoff water (7) in the inner bend (4) of the beam blank profile (10) is lifted in the region of a drain device (6) by the effects of energy-rich nozzle jets (13, 14) directed against the travel direction of the runoff water by the forming of a damming pressure above the lateral profile edges (11) of the inner bend and is guided into a sinter trough (9) arranged thereunder.

2. The method according to claim 1, characterized in that to generate the nozzle jets (13, 14) water under pressure is used.

3. The method according to claim 1, characterized in that to generate the nozzle jets (13, 14) air or an air/water mixture is used.

4. The method according to claim 1, characterized in that the runoff water collected in the sinter trough is supplied to a treatment apparatus for water economy and is recycled to the casting machine.

5. A device for draining runoff water (7) from the inner bend (4) of the strand guide (3) of a beam blank casting machine for carrying out the method according to at least one of the preceding claims, characterized in that the drain device at the lower region of the inner arc of the strand guide (3) is height adjustable between lateral edges (11) of the beam blank profile in guide rails (19) and has a supply pipe (18) connected therewith for a pressure medium to generate the nozzle jets (13, 14).

6. The device according to claim 5, characterized in that cooling water nozzles are provided for spraying the strand (3) and that jet nozzles (8) are arranged for emitting energy-rich nozzle jets directed oppositely to the runoff water (7) in the inner bend (4) of the beam blank profile (10).

7. The device according to claim 5 characterized in that the jet nozzles (8) are configured for generating the nozzle jets (13, 14) for example have an emission pressure in the range of about 10 bar or to produce air jets or nozzle jets of a water/air mixture, for example with an emission pressure of about 6 bar.

8. The device according to claim 5, characterized in that a sinter trough (9) is provided in a region below the drain device (6) to collect runoff water (7) overflowing from the inner bend (4) of the beam blank profile (10) and is equipped with at least one discharge organ (20).

9. The device according to claim 5, characterized in that the drain device is guided to be height adjustable between guide rails (19) at the lower region of the inner bend (4) of the beam blank profile (10) between lateral edge profiles (11) and at an upper end has a supply pipe (18) for a pressure medium (15) which is arranged to be height adjustable in a guide (17).

10. The device according to claim 5, characterized in that the nozzle jets (13, 14) for draining of the runoff water (7) are laterally inclined to the inner bend (4).

11. The device according to claim 5, characterized in that the region of the drain device (6) protective plates (21) are provided on the edges (11) of the beam blank profile (10).

12. The device according to claim 5, characterized in that the sinter trough (9) is connected by the discharge organ (20) with a cleaning and water-recycling apparatus.
